(19) United States
(12) Patent Application Publication
(10) Pub. No.: US 2016/0244341 A1
(43) Pub. Date: Aug. 25, 2016

(54) WATER FILTERS FOR GRAVITY-FED WATER FILTER PITCHERS

(71) Applicant: Whirlpool Corporation, Benton Harbor, MI (US)

(72) Inventors: TIMOTHY J. CAMPBELL, Old Hickory, TN (US); DAVID P. COOPER, Climax, MI (US); BETH M. JACKSON, St. Joseph, MI (US); STEVEN JOHN KUEHL, Stevensville, MI (US); MARK M. SENNINGER, St. Joseph, MI (US)

(21) Appl. No.: 15/052,651

(22) Filed: Feb. 24, 2016

Related U.S. Application Data
(60) Provisional application No. 62/120,012, filed on Feb. 24, 2015.

(51) Int. Cl. C02F 1/28; B01D 15/18; B01D 15/10

(52) U.S. Cl. CPC C02F 1/283; B01D 15/10; B01D 15/18; C02F 2101/12

(57) ABSTRACT

A gravity driven water filter having: a housing with at least one upwardly extending sidewall that extend upwardly from a bottom of the housing and define an interior volume of the housing; a filter media retention screen covering treated water outlets on a bottom of the housing; and a lid closing a top of the housing and enclosing the interior volume of the housing where the lid includes a plurality of water inlet holes, an upwardly extending vent stack, and finger actuated tabular members radially extending from the vent stack and engaged with the vent stack and a top surface of the lid to permit a rotational force to be applied to the housing.

### CROSS-REFERENCE TO RELATED APPLICATIONS

This application claims priority to and the benefit of U.S. Patent Application Ser. No. 62/120,012, entitled “WATER FILTERS FOR GRAVITY-FED WATER FILTER PITCHERS,” which was filed on Feb. 24, 2015, the entire disclosure of which is hereby incorporated by reference.

### SUMMARY

One aspect of the present disclosure is generally directed toward a gravity driven water filter having: a housing with at least one upwardly extending sidewall that extend upwardly from a bottom of the housing and define an interior volume of the housing; a filter media retention screen covering treated water outlets on a bottom of the housing; and a lid closing a top of the housing and enclosing the interior volume of the housing where the lid includes a plurality of water inlet holes, an upwardly extending vent stack, and finger actuated tabular members radially extending from the vent stack and engaged with the vent stack and a top surface of the lid to permit a rotational force to be applied to the housing. The gravity driven water filter has a height of about two inches or less and is free of any indentation or apertures on the at least one upwardly extending sidewall of the gravity driven water filter housing.

Yet another aspect of the present disclosure is generally directed toward a gravity driven water filter that includes: a gravity driven filter housing having at least one first filtration zone inlet and at least one second filtration zone inlet; a first filtration zone within the housing and having a filtration media spaced within and retained in the first filtration zone and configured to receive untreated water from the at least one first filtration zone inlet; a fluid passageway through the first filtration zone where the fluid passageway fluidly couples the at least one second filtration zone inlet and a second filtration zone. The second filtration zone is filled with the filtration media. A first portion of untreated water introduced via the inlet is filtered in the first zone by the filtration media spaced within the first filtration zone, and a second portion of the untreated water bypasses the first zone via the fluid passageway and is filtered in the second zone by the filter media positioned within the second zone.

Another aspect of the present disclosure is generally directed toward a method of using a gravity driven water filter. The method includes the steps of: providing a gravity driven water filter and at least one water pitcher having an untreated water receiving reservoir and a treated water reservoir that receives water that passes through the gravity driven water filter positioned between the untreated water receiving reservoir and the treated water reservoir when the water filter is positioned within a water filter receiving space and wherein the water filter receiving space has at least one protrusion engaged with an interior wall of the filter receiving space; and inserting the gravity driven water filter into the water filter receiving space without engaging the at least one protrusion. The gravity driven water filter used according to the above method and those described and claimed herein may include, but are not limited to the water filters whose structure is disclosed and described herein.

### BRIEF DESCRIPTION OF THE DRAWINGS

FIG. 1 is an example water filter pitcher in which gravity-fed water filters constructed in accordance with the teachings of this disclosure may be used.

FIG. 2 is perspective view of a gravity-fed water filter according to one aspect of the present disclosure that may be used in conjunction with the example water filter pitcher of FIG. 1.

FIG. 3 is an exploded view of the water filter of FIG. 2.

FIG. 4 is a top view of the water filter of FIG. 2.

FIG. 5 is a side cross-sectional view of the water filter of FIG. 2 taken along line V-V of FIG. 4.

FIG. 6 is an expanded view of a portion 6 of the example cross-sectional view of FIG. 5.

FIG. 7 is a schematic diagram illustrating an example multi-tiered water filter structure that may be used as an alternative to implement the example water filter of FIG. 2.

### DETAILED DESCRIPTION

Before the subject invention is described further, it is to be understood that the invention and disclosure are not limited to the particular embodiments described below, as variations of the particular embodiments may be made and still fall within the scope of the appended claims and this disclosure. It is also to be understood that the terminology employed is for the purpose of describing particular embodiments, and is not intended to be limiting. Instead, the scope of the present invention will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention and the present disclosure. The upper and lower limits of these smaller ranges may independently be included in the smaller ranges, and are also encompassed within the invention and the disclosure, subject to any specifically excluded limit in the stated range. Where the stated range includes one or both of the limits, ranges excluding either or both of those included limits are also included in the invention and disclosure.

In this specification and the appended claims, the singular forms “a,” “an” and “the” include plural reference unless the context clearly dictates otherwise.

Some conventional gravity-fed water filtration systems filter water so slowly that customer dissatisfaction can occur. Filtration rate is a product of one or more of: filtration housing size, type of filtration media, cross-sectional area of the filtration media, water pressure, number of times filtration media has been used, whether filtration media is dry or wet, etc. Conventionally, the cross-sectional area of the filtration media of a water filter is approximately the surface area of the top of the water filter's housing, thus, providing an upper limit on filtration rate when used in cross-sectional size constrained implementations, as is common in water filter pitchers using conventional water filters.

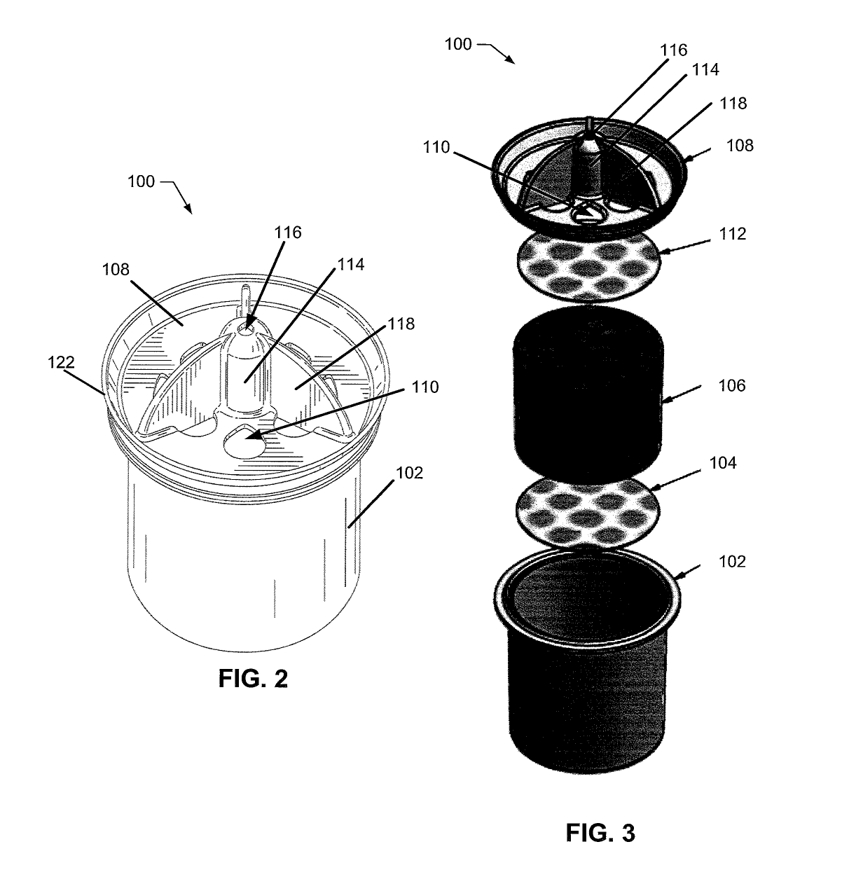

FIG. 2 is an example water filter 100 constructed in accordance with the teachings of this disclosure that provides improved filtration rates and improved usage. FIG. 3 is an exploded view of an example manner of implementing the example water filter 100 of FIG. 2. As shown, the example filter 100 of FIG. 3 has a housing 102 with an open top and a bottom and at least one upwardly extending side wall. The housing is shown as cylindrical shape, but while less preferred conceivably could have any shape, such as a cuboid. The filter 100 further typically includes a bottom screen 104 to retain a filter media 106 in the housing 102. The filter also typically includes a lid 108 having water inlet holes (one of which designated at reference numeral 110) defined therethrough, and a top screen 112 to permit unfiltered water to pass into the filter 100 and to retain the filter media 106 in the housing 102. Filtered water exits the water filter 100 through the bottom screen 104 and out one or more apertures in the bottom of the housing. The inlet holes 110 and the outlet apertures in the bottom may have any ornamental or decorative shape(s) and may be spaced in any manner, but are typically evenly spaced apart from one another on the surface.

The filter media 106 of FIG. 3 typically allows a water flow rate of at least approximately one to two liters per minute. The filter media 106 typically also reduces chlorine, taste and odor components (CTO) per NSF 42 to a minimum of 60 gallons and Atrazine, Benzene, Alachlor and Lindane per NSF 53 for a minimum of 60 gallons. The filter media 106 also typically removes lead, copper, mercury, cadmium and arsenic (pH 6.5 per NSF 53 2004 standard) for up to 60 gallons, sfd. Activated hollow carbon media from Selecto Scientific Inc. described in U.S. Pat. Nos. 6,241,893 and 6,764,601, the entirety of which are hereby incorporated by reference, may be used. The filter media 106 does not typically require any presoaking and does not typically contain any carbon fines, in particular carbon fines that might find their way to the treated water, which often occurs when current carbon-based gravity filters are used.

Advantageously, it has been found that by using the activated hollow carbon manufactured by Selecto Scientific Inc., the housing 102 can be made shorter, e.g., half as tall, than is conventional when using standard activated carbon filter media, thus allowing the example filter 100 to be used in conjunction with gravity-fed water filter pitchers from different manufacturers. Typically the housing is about three inches tall or less, more typically about two and a half inches or less or about two inches or less or about one and a half inches or less. Due to its shorter profile, the filter 100 can be inserted into a pitcher without engaging a manufacture's feature defined in the pitcher, typically in the bottom portion of the pitchers filter receiving aperture, that may uniquely or proprietarily corresponds to their water filters. For example, the housing 102 can fit in a BRITA® water pitcher without being blocked by or needing to engage the “key” structure defined in the BRITA® water pitcher. More generally the “key” structure is a projection that extends into the filter receiving cavity, which typically mates with a corresponding aperture or groove or notch or the filter housing that engages the projection after mating with it. Moreover, using the SELECTO® filter media reduces packaging, carbon footprint, shipping costs, etc. The filter also allows for faster flow to fill the pitcher than traditional standard filters having larger heights. Additionally, housing 102 typically does not have any notches, grooves or apertures that project into or take up interior volume within the housing. The only aperture or indentations on the housing are typically the water inlets 110 and the outlets on the bottom surface of the housing.

To vent air, the example lid 108 of the filter 100 includes an upwardly extending central vent stack 114. The vent stack 114 has a hole 116 at an upper end of the vent stack 114. The vent hole is typically in the center of the vent stack; however, a vent hole may be implemented elsewhere on the vent stack 114. In the illustrated exemplary filter of FIGS. 2 and 3, the vent stack 114 and hole 116 are tear drop shaped, however, any other ornamental or decorative shape(s) may be used for the vent stack 114 and/or the hole 116. As water passes through the filter 100, air vents through the vent stack 114 enabling a faster filtration rate.

In some circumstances, a seal may form between a water filter and a water filter pitcher due to, for example, being left in a longer period of time, disuse, a dry seal, etc. In such circumstances, it may be difficult to remove the water filter, especially for those with, for example, weak grip, diminished hand strength, smaller hands, etc. To facilitate ease of gripping, the example lid 108 includes one or more upwardly extending members, one of which is designated at reference numeral 118. In FIGS. 2 and 3, the members 118 extend radially outwardly from the central vent stack 114 and are also engaged with or integrally formed with the top surface of the water filter to form tabular members. The members 118 may also engage the upwardly extending perimeter lip 122 that typically extends around the circumference of the lid 108. The members typically are planar and are typically engaged with the vent stack and top surface of the lid 108 in an at least substantially perpendicular configuration or in a perpendicular configuration. Advantageously, it has been found that that the use of three angularly spaced members 118 facilitates a strong, comfortable, and secure grip by the index finger, second finger and thumb, which are typically the stronger fingers in the hand. By providing a strong and secure grip, users find it easier to apply a force sufficient to break any adhesive bonds that may have formed between the water filter 100 and a water filter pitcher. Typically, the filter is removed by grasping a plurality of the angular spaced members and pulling upwardly, and optionally twisting the filter while pulling. Twisting helps break the water seal or chemical adhesion that may form between the pitcher and the filter during use. The members 118 extending from the vent stack and engaged to the top surface in combination create a structure that facilitates easier removal of the filter even by those with weaker hands. While the example members 118 are rounded, any other ornamental or decorative shape(s) may be used for the members 118.

In the exemplary filter shown in FIGS. 2 and 3, the housing 102 has a height of approximately 50 millimeters (mm) and a diameter of approximately 45 mm, and the vent stack 114 and members 118 have a height of approximately 20 mm (from about 17 mm to 23 mm). The height of the housing may range from about 35 millimeters to about 75 millimeters in height or more typically from about 35 mm to about 50 mm or anywhere in between either of these ranges and have a housing diameter of from about 35 mm to about 55 mm.

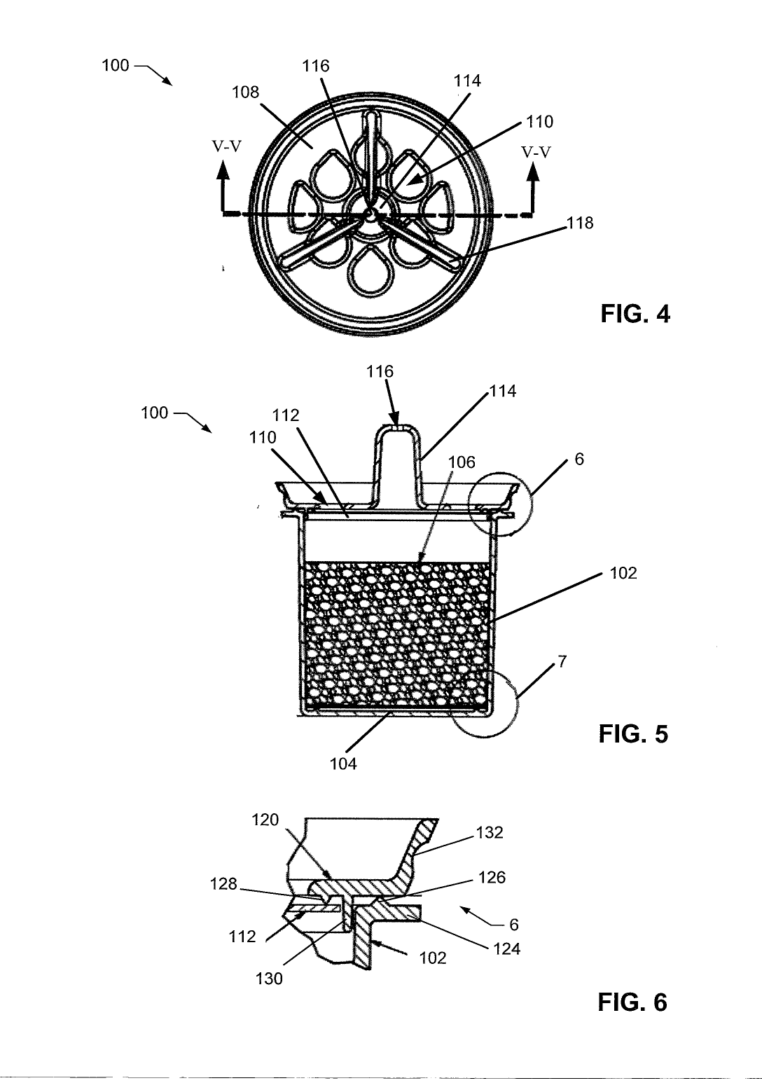

FIG. 4 is a top view of the filter 100. FIG. 5 is a side cross-sectional view of the filter 100 taken along line V-V of FIG. 4.

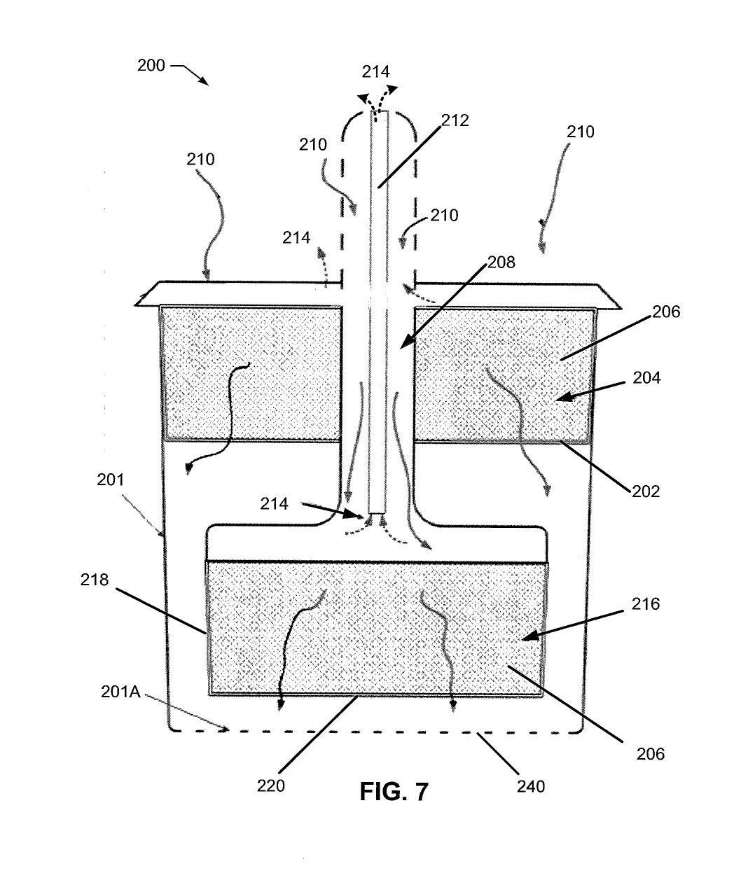

FIG. 6 is a detailed view of a portion 6 of the side cross-sectional view of the filter 100 shown in FIG. 5. As shown in FIG. 6, the housing 102 is attached or affixed to a seal or rim 120 that may also operate to engage or seal the water filter 100 against a surface of a water filter pitcher, thereby, reducing the likelihood that unfiltered water bypasses the water filter 100. The lid 108, in particular the perimeter lip 122 of the lid, and a laterally and outwardly extending portion cooperate to engage or seal the filter 100 in an engaged position. Additionally, as shown in FIG. 6, the laterally and outwardly extending portion 124 of the housing may further include a top lid engaging projection 126 that engages a bottom surface of the top lid 108 Similarly, an inward portion of the top lip has a projection 128 that engages top screen portion and to help force untreated water to pass through the screen 112. A downwardly extending housing overlap extension 130 also is typically positioned outside the projection 128 and engage, typically in a water-tight manner, with the housing 102 as shown in FIGS. 6 and 7. All of the projections 126, 128 and the extension, typically extend around substantially all or all of the perimeter of the outwardly extending portion 124 and the top lid 108 and typically form a ring on the surfaces they project from. The upwardly extending perimeter lip may have an arcuate portion 132 around the exterior facing surface thereof.

Returning to FIG. 5, the housing 102 may have an integral rounded corner (see portion 7) to reduce filter media washout caused by exiting filtered water. Such washout could create a path for unfiltered water to bypass an adequate depth of filtration resulting in lowered customer satisfaction.

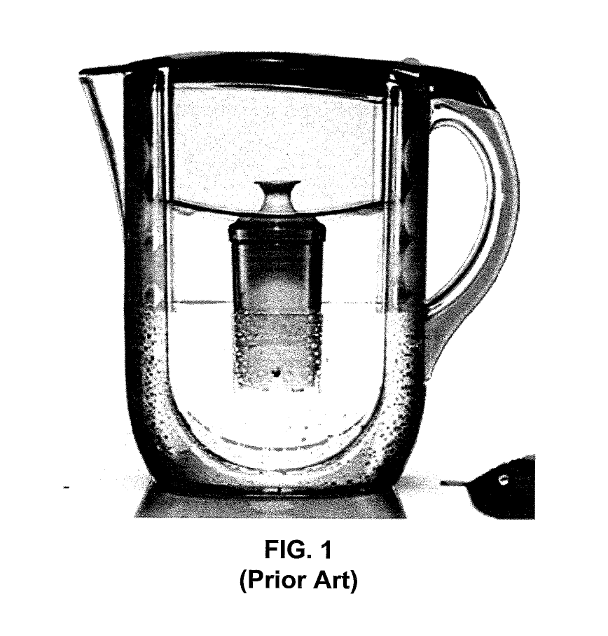

FIG. 7 illustrates an example multi-tiered water filter 200 that may alternatively be used to implement filtration for the water filter 100. While the example multi-tiered water filter structure 200 is described in connection with a gravity-fed water filtration pitcher, it may also be used in other filtration system(s). In a two-tier configuration, the filtration media cross-sectional area can be approximately doubled leading to approximately a doubling in water filtration rate. Such solutions can enable filtration rates of two liters per minute (lpm) for a drinking water filtration pitcher such as that shown in FIG. 1. By dividing the gravity-driven water flow, as shown in FIG. 7, and providing an additional tier of filtration media in the housing, the effective surface area can be approximately doubled, thus, providing for a substantial increase in flow-area cross section for filtration. While two-tiered water filters are shown in examples herein, it should be understood that other numbers of tiers may be implemented. In some examples, a multi-tiered water filter constructed in accordance with the teachings of this disclosure is implemented for a water filtration pitcher such as that shown in FIG. 1. It should be appreciated that multi-tiered water filters may be used in other systems and may be used to filter or treat liquids other than potable water.

Turning to FIG. 7, an exemplary two-tiered water filter 200 implemented within a housing or canister 201, such as the example housing 102, is shown. The housing or canister 201 includes a bottom 201A having openings 240 to allow water to pass through and, in some examples, the interior bottom surface or the openings include a screen to help retain filtration material or media in the housing or canister 201. In the example of FIG. 7, the two-tiered water filter 200 has a screen 202 below a first zone, area, region, etc. 204 of filtration material 206 to retain the filtration material 206 in place. The example filter 200 of FIG. 7 has a fluid passage way 208 in the form of a center pass-through tube for unfiltered water 210 to flow downward. An air passageway 212 in the form of concentric inner passage or tube or vent is provided to vent trapped air 214. In some examples, the filter 200 has a lid such as the lid 108 having a vent stack such as the vent stack 114 implementing the passageway 208 and the vent 214, and the members 118.

As shown, the example filter 200 has a second zone, area, region, etc. 216 of the filtration material 206 that filters the unfiltered water 210 that bypasses the first region 204 via the fluid passageway 208. The zone 216 is contained in a second canister 218 that allows water filtered in the first zone 204 to pass through a passageway (e.g., a concentric annulus) formed between the interior of the canister wall 201 and the exterior of the second canister 218.

In practice, the flow of the unfiltered water 210 is unimpeded until the water 210 begins to flow through the media 216. At this point flow resistance helps to divide the total flow by backing up the initial flow stream such that a portion of the pooled water can take the secondary flow path 208 to the second layer filter 216.

Internal wall curving or radiusing the junction of the side wall of the second canister 218 and its screened bottom wall 220 may be implemented to reduce media washout caused by water out-flowing from the zone 216 down along the interior of the second canister 218. Such washout could create a path for unfiltered water to bypass an adequate depth of filtration resulting in lowered customer satisfaction. The exterior radius of the junction of the side wall of the second canister 218 and its screened bottom wall 220 or a slight protruding lip will cause water from the first zone area to shed off of the second canister 218 and not cause a surface tension induced blockage on its screened bottom wall 220. As shown, inclusion of the second zone 216 approximately doubles the cross-sectional surface area of the first zone 204, thus, approximately doubling the effective filtration cross-sectional area and, thus, the filtration rate of the filter 200. Thus, essentially about twice the filtration capacity may be implemented within the same cross-section as a conventional water filter. When used in conjunction with filter media, such as activated hollow carbon manufactured by Selecto Scientific Inc., the multi-tiered filter structure of FIG. 7 can approximately double filter rate without increasing the height or width of the filter. That is, because the Selecto® filter media allows for reduction of filter media height by approximately 50% and because of the structural features of the filter that increase the effective cross-sectional filter area, the two-tier filter arrangement shown in FIG. 7 has a height similar to a conventional one-tier filter that uses a conventional carbon filter media, but has approximately double the filtration rate or a greater rate. For clarity of illustration, the passageways 208 and 212 are drawn to have different dimensions in FIG. 7 than they may be in practice.

As used herein, terms such as up, down, top, bottom, side, end, front, back, etc. are used with reference to the normal or currently considered orientation of an item, member, assembly, element, etc. If any of these is considered with respect to another orientation, it should be understood that such terms need to be correspondingly modified.

The connecting lines, or connectors shown in the various figures presented are intended to represent exemplary functional relationships and/or physical or logical couplings between the various elements. It should be noted that many alternative or additional functional relationships, physical connections or logical connections may be present in a practical device.

Any use of relative terms, such as quicker, faster, etc., when describing the disclosed examples are only used to indicate that the disclosed examples are able to filter water at a faster rate than conventional prior-art solutions. Such terms are not to be construed as requiring or specifying that water be filtered at a particular rate. For example, the rate at which water can be filtered depends on, for example, age of filtration media, type of filtration media, filter geometry, etc.

As used herein, fluidly coupled, or variants thereof, refers to the coupling of, for example, two devices so that a fluid, such as water, in its liquid state may be flowed, transferred or otherwise moved between the two devices.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A gravity driven water filter comprising:
a gravity driven filter housing having at least one first filtration zone inlet and at least one second filtration zone inlet;
a first filtration zone within the housing and having a filtration media spaced within and retained in the first filtration zone and configured to receive untreated water from the at least one first filtration zone inlet;
a fluid passageway through the first filtration zone where the fluid passageway fluidly couples the at least one second filtration zone inlet and a second filtration zone; and
wherein the second filtration zone is filled with the filtration media,
wherein a first portion of untreated water introduced via the inlet is filtered in the first zone by the filtration media spaced within the first filtration zone, and a second portion of the untreated water bypasses the first zone via the fluid passageway and is filtered in the second zone by the filter media positioned within the second zone.

2. The gravity driven water filter of claim 1, wherein the first filtration zone is positioned above and spaced apart from the second filtration zone and each zone is defined by a filtration media retaining interior housing positioned within the gravity driven filter housing and wherein the water is driven through the filter by only the force of gravity during normal operation.

3. The gravity driven water filter of claim 1 further comprising a lid closing a top of the housing and having the at least one first filtration zone inlet and the at least one second filtration inlet, an upwardly extending vent stack, and members radially extending from the vent stack and engaged with the vent stack and a top surface of the lid where the members are finger receiving tabular members that permit a rotational force to be applied to the housing by a user's fingers.

4. The gravity driven water filter of claim 1, wherein the fluid passageway provides an air escape pathway for air leaving the first filtration zone and the gravity driven water filter has a height of from about 35 mm to about 50 mm and is free of any indentation on an upwardly extending sidewall of the gravity driven water filter housing.

5. The gravity driven water filter of claim 4, wherein the fluid passageway has a second passageway within it that provides an air escape pathway for air leaving the second filtration zone.

6. The gravity driven water filter of claim 1, wherein the fluid passageway comprises an at least substantially cylindrical passageway with an air pathway spaced within the at least substantially cylindrical passageway that is the second passageway where the air pathway is a cylindrically shaped tube extending from the top of the fluid passageway into the second filtration zone; and
wherein the fluid passageway permits air from the first filtration zone to flow out of the gravity driven water filter through the at least one second filtration zone inlet and also permits untreated water to flow into the at least one second filtration zone inlet where the at least one second filtration zone inlet is positioned along the fluid passageway above a lid closing the top of the housing.

7. The gravity driven water filter of claim 6, wherein the at least one first filtration zone inlet and the at least one second filtration zone inlet each comprise a plurality of inlets.

8. The gravity driven water filter of claim 1, wherein water that does not pass into the first filtration zone passes into the fluid passageway and into the second filtration zone and the filtration media comprises activated hollow carbon.

9. The gravity driven water filter of claim 1, wherein the filter media of the first filtration zone and the second filtration zone each:
allows a water flow rate of at least approximately one to two liters per minute;
reduces chlorine, taste and odor components (CTO) per NSF 42 to a minimum of 60 gallons and Atrazine, Benzene, Alachlor and Lindane per NSF 53 for a minimum of 60 gallons; and
removes lead, copper, mercury, cadmium and arsenic (pH 6.5 per NSF 53 2004 standard) for up to 60 gallons, sfd.

10. A gravity driven water filter comprising:
a housing having at least one upwardly extending sidewall that extend upwardly from a bottom of the housing and define an interior volume of the housing;
a filter media retention screen covering treated water outlets on a bottom of the housing; and
a lid closing a top of the housing and enclosing the interior volume of the housing where the lid comprises a plurality of water inlet holes, an upwardly extending vent stack, and finger actuated tabular members radially extending from the vent stack and engaged with the vent stack and a top surface of the lid to permit a rotational force to be applied to the housing; and
wherein the gravity driven water filter has a height of about two inches or less and is free of any indentation on the at least one upwardly extending sidewall of the gravity driven water filter housing.

11. The gravity driven water filter of claim 10, wherein the lid has three angularly spaced members extending upward are configured to receive two fingers and a thumb and the gravity driven water filter has a height of about one and a half inches or less.

12. The gravity driven water filter of claim 10, wherein the vent stack has a hole at a top end of the vent stack that is in airflow communication with interior volume of the housing and wherein the interior volume of the gravity driven water filter comprises two filtration zones that are spaced apart from one another where each zone separately receives and treats untreated water and wherein at least one of the water filtration zones comprise an activated hollow carbon filtration media that reduces chlorine, taste and odor components (CTO) per NSF 42 to a minimum of 60 gallons and Atrazine, Benzene, Alachlor and Lindane per NSF 53 for a minimum of 60 gallons; and removes lead, copper, mercury, cadmium and arsenic (pH 6.5 per NSF 53 2004 standard) for up to 60 gallons, sfd.

13. The gravity driven water filter of claim 10, wherein the lid further comprises a rim and seal that facilitates installation of the water filter in water filter pitchers from different manufacturers.

14. The gravity driven water filter of claim 10, wherein the filter media comprises activated hollow carbon.

15. The gravity driven water filter of claim 14, wherein the filter media provides a water flow rate of at least approximately one to two liters per minute.

16. The gravity driven water filter of claim 15, wherein the filter media:
reduces chlorine, taste and odor components (CTO) per NSF 42 to a minimum of 60 gallons and Atrazine, Benzene, Alachlor and Lindane per NSF 53 for a minimum of 60 gallons; and
removes lead, copper, mercury, cadmium and arsenic (pH 6.5 per NSF 53 2004 standard) for up to 60 gallons, sfd.

17. A method of using a gravity driven water filter, comprising the steps of:
providing a gravity driven water filter and at least one water pitcher having an untreated water receiving reservoir and a treated water reservoir that receives water that passes through the gravity driven water filter positioned between the untreated water receiving reservoir and the treated water reservoir when the water filter is positioned within a water filter receiving space and wherein the water filter receiving space has at least one protrusion engaged with an interior wall of the filter receiving space; and
inserting the gravity driven water filter into the water filter receiving space without engaging the at least one protrusion.

18. The method of claim 17, wherein the gravity driven water filter, when positioned within the water filter receiving space is above at least one protrusion and still forms a water tight seal to enable treatment of water traveling from the untreated water receiving reservoir and through the filter into the treated water reservoir.

19. The method of claim 18, further comprising the steps of:
grasping angularly spaced members extending upward from the gravity driven water filter;
rotating the gravity driven water filter using the members; and
lifting the gravity driven water filter out of the pitcher using the members.

20. The method of claim 19, further comprising adding untreated water to the untreated water receiving reservoir; and allowing air to escape through a vent stack of the gravity driven water pitcher as the water is added and wherein the gravity driven water filter is free of any aperture or recess or other feature designed to matingly receive the protrusion within the water filter receiving space.
